(19) United States
(12) Patent Application Publication
(10) Pub. No.: US 2010/0208756 A1
(43) Pub. Date: Aug. 19, 2010

(54) TUNABLE LASER MODULE BASED ON POLYMER WAVEGUIDES

(76) Inventor: Young-Ouk Noh, Gyeonggi-do, (KR)

Correspondence Address: CLARK & BRODY, 1700 Diagonal Road, Suite 510, Alexandria, VA, 22314, US

(21) Appl. No.: 12/532,708

(22) PCT Filed: Jul. 25, 2008
(86) PCT No.: PCT/KR2008/004353

§ 371 Date: Mar. 29, 2010

(30) Foreign Application Priority Data
Jul. 27, 2007 (KR) 10-2007-0075807

(51) Int. Cl. H01S 3/10

(52) U.S. Cl. 372/20

(57) ABSTRACT

The present invention relates to a laser module based on a waveguide tunable in a broad wavelength band. More specifically, the laser module comprises: a broadband light source based on an external resonator that generates optical signals; a waveguide; at least one Bragg grating formed on the waveguide; an optical lens provided between the light source and the waveguide; a first temperature controlling device configured of a thin film heater; and a second temperature controlling device that includes a temperature sensor and a thermoelectric cooler, wherein the light output from the light source being condensed through the optical lens and input to the waveguide, and a reflecting band of the Bragg grating is controlled by a thermo-optic effect, and an oscillation wavelength is controlled by a second temperature controlling device independently of external temperature environment.

### TECHNICAL FIELD

The present invention relates to a tunable laser module based on a polymer waveguides.

### BACKGROUND ART

A wavelength division multiplexing (WDM) optical communication technology, which is currently applied to most backbone networks and metro networks, is a technology of transmitting a plurality of high speed signals to an optical path configured of one optical fiber by performing the wavelength division multiplexing thereon. The transmission network according to the WDM scheme essentially needs an optical add/drop multiplexer function that can selectively branch/couple some of optical wavelengths without performing photoelectric conversion and pass some of the optical wavelengths. The OADM connects between intermediate nodes existing in transmission lines in a wavelength unit, making it possible to extend the connectivity of the network and increase the efficiency of the network. An ROADM (Reconfigurable OADM) can reconfigure the branch/coupling wavelengths and effectively reconfigure a wavelength connection state of an overall network at a remote place without arranging technical experts to flexibly cope with the change in traffic situation, making it possible to surprisingly reduce the maintenance cost of the network.

The ROADM has largely been divided and used into a switch based structure and a broadcast and select (BS) scheme based structure. Recently, the latter scheme has less path loss when accommodating a plurality of nodes, such that it supporters as a preferable scheme in the ROADM system. As core components configuring the ROADM system in the BS scheme, there are an optical distributor, a wavelength multiplexer/demultiplexer, a variable optical attenuator (VOA), a tunable filter, and a tunable laser, etc. In particular, as the most important component of the ROADM system, a tunable transponder in which the integrated tunable filter and tunable filter is integrated provides a function that can tune the wavelength at a remote place to reconfigure the network, such that network operators can reduce a stock burden of optical components for a backup, reduce time required to manage the network, and add/drop any wavelengths upon selecting the wavelengths of add/drop to effectively cope with the change in traffic situation, making it possible to most effectively reduce the maintenance cost of the network.

However, the tunable filter technology is not yet grown and the tunable laser is very expensive, such that it is very difficult to develop the tunable transponder.

In the case of the tunable filter, an optical fiber Bragg grating based filter has currently developed and used; however, it has very slow tunable response time of five seconds and is very expensive, such that it is not well used in a commercial system.

In the case of the tunable laser, a laser using a distributed feedback (DFB) structure has been developed and used; however, the DFB laser has a narrow tunable range of 10 nm so that it should use three and four sets of tunable DFB laser modules in order to support all wavelengths within a C-band (1535 nm to 1565 nm). Also, a light source of the tunable transponder using the DFB laser is expensive so that the transponder should have a multi-channel transponder for a backup. As a result, the tunable transponder using the DFB laser does not provide an effective solution to reduce the stock burden of the network operators.

Therefore, in order to implement the tunable transponder for the ROADM system having high efficiency and economical efficiency, a need exists for a development of a tunable light source based on an external resonator using a tunable filter that can tune all necessary wavelengths of a WDM band (for example, C-band) provides a broadband tunable function by using one module.

As the tunable filter technologies, there are a tunable Fabry-Perot filter, a micro machined device, a Mach-Zehnder interferometer, fiber Bragg gratings, acousto-optic tunable filters, Electro-optic tunable filters, an arrayed waveguide grating (AWG), an active filter, ring resonator tunable filters, etc.

Such a tunable filter was well described in “Tunable Optical Filters for Dense WDM Networks” published in pp. 50-55 of IEEE Communications Magazine, December, 1998, by D. Sadot and E. Boimovich.

A tunable filter technology based on a polymer waveguide using a Bragg grating is first implemented in “Tunable wavelength filters with Bragg gratings in polymer waveguides” published in pp. 2543, 2545 of Applied Physics Letters, December (no 2), 1998, by M. Oh, et al. and the technology associated therewith is registered as US patent (U.S. Pat. No. 6,303,040B1), 2001.

The related art for implementing the tunable filter based on the polymer waveguide, which is a technology that selectively reflects or transmits light with a necessary specific wavelength by changing a refraction index in a medium using a thermo-optic effect, used a heating element (generally metal thin film) capable of locally generating heat to an upper end of the waveguide in order to tune an operating wavelength of the filter by changing an effective refractive index in the polymer waveguide.

However, the related art using a metal heating element cannot provide a uniform operating wavelength of the filter at any time regardless of external environment since a relation between a caloric value generated in the metal heating element and the necessary operating wavelength of the filter varies according to external environment when external temperature varies.

Also, a technology using the tunable filter based on the polymer waveguide as an output coupler of the an external resonator-type tunable laser was proposed in “over 26-nm wavelength tunable external cavity laser based on polymer waveguide platforms for WDM access networks” published, pp. 2102-2104 of IEEE Photonics Technology Letters, October (no. 20), 2006, by G. Jeong, et al.

In the published article, the tunable technology used the tunable technology and the tunable method used the metal thin film heating element being a method devised by M. Oh, etc. In this case, however, the article has the problems of the metal thin film heating element for the aforementioned tunable filter operation as it is. Therefore, when the tunable filter based on the polymer waveguide is used as the output coupler of the laser based on the external resonator, it has the problems of operation characteristics independently of the external environment, a secure of stability in a repetitive operation, etc.

Since the laser based on the external resonance proposed by G. Jeong, et al. used a structure of aligning and coupling a laser diode chip for a broadband light source and a polymer Bragg grating filter by using a flip chip connection method, when inputting and outputting light output from the laser diode to the waveguide including the Bragg grating, the magnitude in the light source and waveguide modes is different from each other, the laser has a problem of low coupling efficiency. With the low coupling efficiency, it is reported that the output power of the tunable laser in the published technology is output characteristic of −5 dBm. The optical communication system for the current ROADM requires the light output power of the tunable laser of 0 dBm or more so that the published technology does not satisfy the requirements of the system.

Also, the laser diode mounting technology of the flip chip connection method proposed by G. Jeong, et al. has a very small core height of the waveguide of 4.5 μm so that it is difficult to mount the laser diode to show the uniform coupling efficiency. As a result, the laser diode mounting technology has a problem of low yield in a mass production. Also, since the laser diode chip of the laser based on the external resonator published by G. Jeong et al. used an open structure without a package, it has a problem of low thermal/electrical/mechanical stability.

### DISCLOSURE

### Technical Problem

In order to solve the aforementioned problems, it is an object of the present invention to provide a laser module based on new external resonator that effectively couples light output from a laser diode to a waveguide including a Bragg grating and to provide a tunable laser module based on an external resonator that can generate a laser oscillation wavelength with stability, reproducibility, and reliability independently of external environment, tune a wavelength to 30 nm or more with a high output and a narrow bandwidth, and have high production yield and secure thermal/electrical/mechanical stability of the laser diode chip itself.

### Technical Solution

A tunable laser module based on an external cavity resonance waveguide of the present invention, comprises: a broadband light source based on the III-V semiconductor external resonator that generates light; a waveguide; at least one Bragg grating formed on the waveguide; an optical lens provided between the light source and the waveguide; a first temperature controlling device that includes a thin film heater formed on the waveguide provided with the Bragg grating; and a second temperature controlling device that includes a temperature sensor and a thermoelectric cooler, wherein the light output from the light source being focused condensed through the optical lens and input to the waveguide, and a reflecting band of the Bragg grating is controlled by a first temperature controlling device using a thermo-optic effect, and an oscillation wavelength tuning is controlled by a second temperature controlling device independently of external temperature environment.

The broadband light source is a semiconductor laser diode chip for TO-can packaged broadband wavelength oscillation, an emitting surface of laser beam is provided with an anti-reflective coating with reflectance of 1% or less, and a corresponding surface of the emitting surface is provided with a high reflective layer having reflectance of 80% or more. Preferably, the waveguide is formed using a polymer.

The inside or the outside of the TO-can package is provided with a third temperature controlling device including a temperature sensor and a thermoelectric cooler, thereby controlling the temperature of the semiconductor laser diode chip to a specific temperature.

Preferably, the temperature sensor of the second temperature controlling device is provided at the lower of the waveguide provided with the Bragg grating, the thermoelectric cooler of the second temperature controlling device is provided at the lower of the waveguide formed with the Bragg grating, and the thin film heater of the first temperature controlling device is provided with an upper of the Bragg grating. More preferably, the waveguide is provided on the upper of the substrate, the temperature sensor of the second temperature controlling device is positioned at the lower of the substrate, a temperature sensor supporting layer is provided at the lower of the temperature sensor, and the thermoelectric cooler is provided at the lower of the temperature sensor supporting layer.

The polymer waveguide as well as the Bragg grating is also a polymer Bragg grating made of a polymer material, the polymer forming the waveguide or the Bragg grating includes a halogen element and a functional group cured by ultraviolet rays or heat. Preferably, the polymer forming the waveguide or the Bragg grating has a thermo-optic coefficient of −9.9×10⁻¹ to −0.5×10⁻⁴° C.⁻¹, more preferably, −3.5×10⁻⁴ to −1.5×10⁻⁴° C.⁻¹.

A central wavelength of the reflecting band of the Bragg grating is controlled to 30 nm or more by the first temperature controlling device to control a central wavelength of the oscillated laser beam to 30 nm or more and the power of the oscillated laser beam is 0 dBm or more and a Full Width Half Maximum (FWHM) of the central wavelength of the oscillated laser beam is 0.3 nm or less.

The waveguide is configured of a core and a clad, the core or the clad may be formed with the Bragg grating, the refractive index of a material forming the core is higher than the refractive index of a material forming the clad, the refractive index of a material forming the Bragg grating is preferably the refractive index of a material forming the core to the refractive index of a material forming the clad.

The two or more Bragg grating is periodically connected to the single waveguide in serial, orders of the two or more Bragg gratings have 1, 3, 5, or 7 orders independently from each other, a geometry of the waveguide may preferably be a rib structure, a ridge structure, an inverted rib structure, an inverted ridge structure, or a channel structure.

Both sides of the lens are preferably formed with the anti-reflective coating and the lens is provided at the inside or outside of the TO-can package to be integrated with the TO-can package.

A light incidence surface of the waveguide is preferably formed with the anti-reflective coating with the reflectance of 1% or less, and the light incidence surface of the waveguide or a portion of the incidence surface including at least core is preferably a tilt surface tilted at 3° to 13° to a vertical surface of a progress direction of the incidence light. When the tilt surface is formed at the light incidence surface of the waveguide, a portion including the core forming the incidence surface among the waveguide cores is formed at an angle satisfying Snell's law.

The tunable laser module based on the external resonance waveguide may further include an optical fiber supporter in a V-groove form at an end of the waveguide and the tunable laser module based on the external resonance waveguide is mounted in an active alignment scheme.

### Advantageous Effects

The tunable laser module based on the external resonance waveguide of the present invention includes a condensing lens between the light source and the waveguide, making it possible to increase the optical coupling efficiency between the light source and the output coupler and to increase the output of the tunable laser and uses the polymer waveguide Bragg grating filter having the high thermo-optic coefficient, making it possible to generate all wavelengths within the C-band or the L-band being one of the optical communication bands using the single laser module. Also, the tunable laser module based on external resonance waveguide of the present invention uses the temperature controlling device including the temperature sensor in the light source and the Bragg grating filter, respectively, to create the thermal environment independently from the external environment, making it possible to stably obtain the wavelength with reproducibility and reliability. The tunable laser module based on the external resonance waveguide of the present invention uses the TO-can packaged light source, making it possible to increase the thermal/electrical/mechanical stability of the broadband oscillation laser diode chip and increase the yield through the introduction of the active alignment structure when mounting the Bragg grating filter, the TO-can packaged light source, and the V-groove.

### DESCRIPTION OF DRAWINGS

The above and other objects, features and advantages of the present invention will become apparent from the following description of preferred embodiments given in conjunction with the accompanying drawings, in which:

FIG. 1 is a configuration view of one example of a laser module based on an external resonance of the present invention;

FIG. 2 shows one example of an active mounting method of the laser module based on the external resonance of the present invention;

FIG. 3 is one example of a configuration view of a tunable laser module based on an external resonance waveguide of the present invention;

FIG. 4 shows one example of the active mounting method of the laser module based on the external resonance light waveguide of the present invention;

FIG. 5 is a wavelength spectrum of a broadband light source of the laser module based on the external resonance light waveguide of the present invention;

FIG. 6 is a diagrammatical view for explaining an operating principle of the tunable and oscillation of the tunable laser module based on the external resonance waveguide of the present invention;

FIG. 7 is a view showing one example of a detailed structure of the tunable laser module based on the external resonance waveguide of the present invention and a formation position of the Bragg grating;

FIG. 8 is a scanning electron microscopy (SEM) photograph of the Bragg grating having a surface relief structure of the tunable laser module based on the external resonance waveguide of the present invention;

FIG. 9 is a view showing one example a detailed structure of a light incidence surface of the waveguide of the tunable laser module based on the external resonance waveguide of the present invention;

FIG. 10 is a view showing a measurement of an oscillated laser beam of the tunable laser module based on the external resonance waveguide of the present invention; and

FIG. 11 is a view showing a measurement of a central wavelength of the oscillated laser beam according to temperature due to an operation of a thin film heater of the tunable laser module based on the external resonance waveguide of the present invention

### DETAILED DESCRIPTION OF MAIN ELEMENTS

100, 100′: TO-can packaged light source
110, 110′: Laser diode chip
120, 120′: Optical lens
200, 200′: Waveguide
210, 220, 210′, 220′: Clad
240, 240′: Bragg grating
250: substrate
300, 300′: Optical fiber supporter
410, 510: Temperature sensor
420: Thin film heater
430: Thermoelectric cooler
520: Thermoelectric cooler
1: ultraviolet or thermosetting curing resin

### BEST MODE

Hereinafter, a tunable laser module based on an external resonance waveguide of the present invention will be described in detail with reference to accompanying drawings. The following proposed drawings are provided as one example to sufficiently transfer to an idea of the present invention to those skilled in the art. Therefore, the present invention is not limited to the following proposed drawings and can be embodied in other forms. Also, like reference numerals throughout the specification denote like components.

At this time, technology terms and scientific terms used in the specification have meanings understood by those skilled in the art unless otherwise defined and the detailed description of known functions and configurations will be omitted in the following description and the accompanying drawings so as not to obscure the subject of the present invention with unnecessary detail.

FIG. 1 is a configuration view of one example of a tunable laser module based on an external resonance waveguide of the present invention. As can be appreciated from FIG. 1, The module includes a light source 110 based on an external resonator that generates light, a waveguide 200 including a Bragg grating 240, and an optical lens 120. Light output from the light source 110 is condensed through the optical lens 120 and input to the waveguide 200. Preferably, the light source is a TO-can packaged (100) semiconductor laser diode 110 and the lens 120 is provided inside the TO-can package 100.

Preferably, both sides of the lens 120 is formed with anti-reflective coatings with the reflectance of 1% or less to prevent light output the light source from reflecting from the lens. As shown by a dotted arrow of FIG. 1, the light source 110 and the waveguide 200 are connected through a condensing process of the lens 120, which is core features of the present invention, not a physical connection. To be specific, the waveguide 200 includes an upper clad 210 and a lower clad 220 deriving total reflection and a core 230 transmitting light, wherein light condensed by the lens 120 is input to the core 230. Preferably, a focus of a lens surface facing the waveguide 200 is an input surface of the core 230 receiving light from the lens 120. At this time, the optical waveguide 200 may be provided on a substrate 250 for a physical support.

As shown by a numeral 300 of FIG. 1, the module may further comprise an optical fiber supporter 300 in a V-groove form that support and fix an optical fiber at an end of the waveguide 200.

With the structure where the light source 110 and the waveguide 200 is connected by the lens 120, a TO-can package 100 including the lens, the waveguide 200, and the optical fiber supporter 300 may be mounted on a mechanical bench for a physical support in an active alignment scheme.

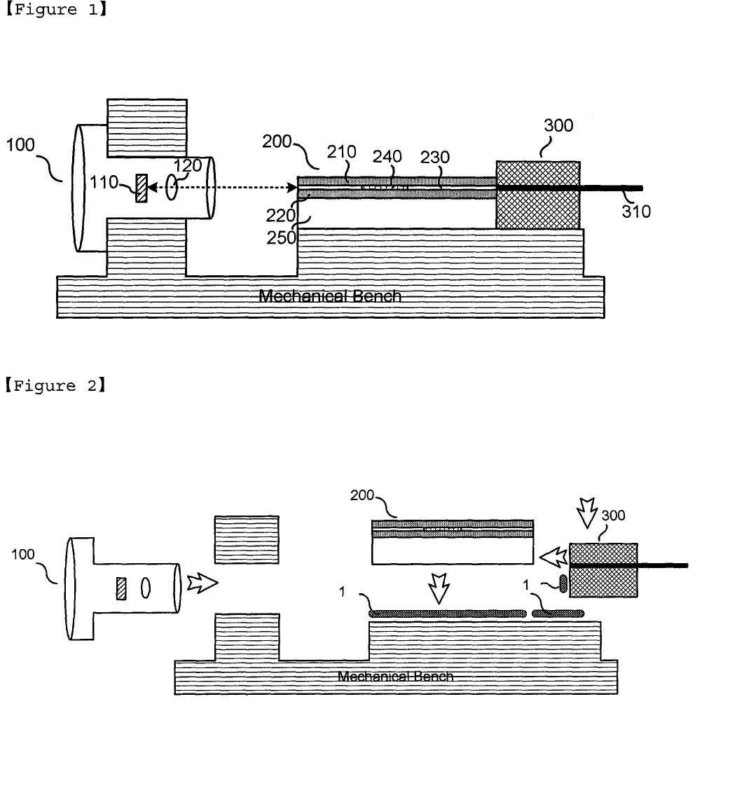

In detail, as shown in FIG. 2, the waveguide 200 and the optical fiber supporter 300 is mounted on the mechanical bench by using ultraviolet or thermosetting polymer resin 1, and the TO-can package 100 may be mounted by a mechanical coupling with the mechanical bench. More specifically, the mechanical coupling can be coupled with an alignment of light axes using a laser welder.

The laser module based on the external resonator of the present invention has a structure where the light source and the waveguide is connected through the optical lens, not having a structure where they are physically connected, making it possible to greatly increase the coupling efficiency, increase the production efficiency, lower the defect rate by the active aligning method of the waveguides.

Both sides of the lens are formed with an anti-reflective coating to prevent light output from the light source from reflecting therefrom. Preferably, the lens is provided inside the TO-can package to input light condensed by the lens through the active mounting of the TO-can package to the waveguide.

The tunable laser module based on the external resonance waveguide of the present invention may further comprise the optical fiber supporter in a V-groove form at the end of the waveguide to which light is output and the tunable laser module based on the external resonance waveguide of the present invention may be mounted in the active aligning scheme.

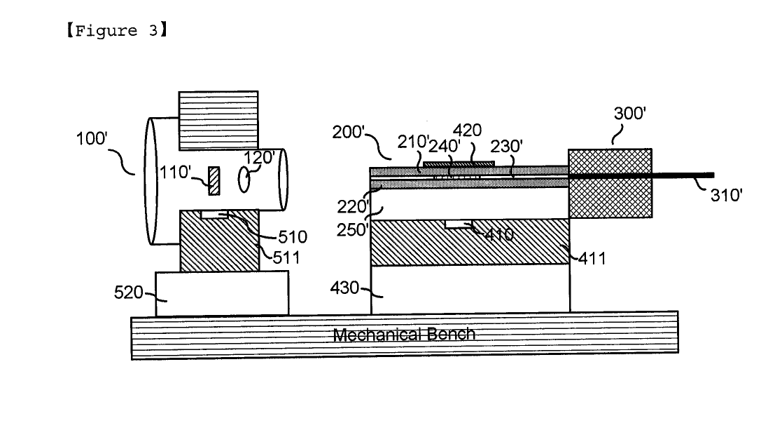

FIGS. 1 and 2 are views for explaining in detail the lens being one characteristic configuration of the tunable laser module based on the external resonance waveguide of the present invention. The preferred tunable laser module based on the external resonance waveguide of the present invention has a configuration as shown in FIG. 3.

FIG. 3 is a configuration view of the tunable laser module based on the external resonance waveguide of the present invention. As described with reference to FIG. 1, since the light source and the waveguide are connected by the lens and the wavelength band of the oscillated laser beam is controlled by the thermo-optic effect, the configuration similar to FIG. 1 is denoted using a symbol (′). Therefore, in the following description, the description of the configuration of FIG. 1 is similarly applied to the detailed description of the configuration denoted by the symbol (′).

As appreciated from FIG. 3, the tunable laser module based on the external resonance waveguide of the present invention includes a broadband light source 110′ based on an external resonator that generates optical signals, a waveguide 200′, one or more Bragg grating 240′ formed on the waveguide, a first temperature controlling device that includes an optical lens 120′ and a thin film heater 420 provided between the light source 110′ and the waveguide 200′, and a second temperature controlling device that includes a temperature sensor 410 and a thermoelectric cooler 430, wherein light output from the light source 110′ is condensed through the optical lens 120′ and then input to the waveguide 200′ and a reflecting band of a Bragg grating 240′ is controlled according to the thermo-optic effect by the first temperature controlling device and the reflecting band is controlled independently of the external temperature environment by the second temperature controlling device. Preferably, the broadband light source 110′ is a TO-can packaged (100′) semiconductor laser diode chip 110′ for broadband wavelength oscillation.

In the broadband light source 110′, an laser light emitting surface is provided with an anti-reflective coating having reflectance of 1% or less, a corresponding surface of the emitting surface is provided with a high reflective layer with reflectance of 80% or more, the wavelength reflected from the Bragg grating 240′ is oscillated by a feedback, which back inputs the reflected wavelength to the emitting surface, to obtain a laser beam having a reflecting band of the Bragg grating and a central wavelength of the reflecting band.

Also, the module may comprises third temperature controlling devices 510 and 520 independently controlled from the second temperature controlling device. The third temperature controlling device including the temperature sensor 510 and the thermoelectric cooler 520 is provided inside or outside of the TO-can package 100′ to control the temperature of the semiconductor laser diode chip 110′ independently from the external temperature environment. The temperature of the semiconductor laser diode chip 110′ is controlled by the third temperature controlling device independently from the external temperature environment so that a central wavelength of a Fabry-Perot resonance mode of the semiconductor laser diode chip 110′ is controlled. At this time, the controlled central wavelength preferably conforms to the wavelength reflected from the Bragg grating 240′. When the central wavelength of the Fabry-Perot resonance mode oscillated from the semiconductor laser diode does not conform to the central wavelength of the Bragg grating, a case where the output of laser is not maximized may occur. In this case, the third temperature controlling device is used to conform the central wavelength of the Fabry-Perot resonance mode to the central operation wavelength of the Bragg filter.

In order to generate an effective an accurate thermo-optic effect, preferably, a temperature sensor 410 of the second temperature controlling device is provided at the lower of the waveguide in which a Bragg grating 240′ is formed, a thermoelectric cooler 430 of the second temperature controlling device is provided at the lower of the waveguide in which the Bragg grating 240′ is formed, and a thin film heater 420 of the first temperature controlling device is provided at the upper of the waveguide in which the Bragg grating 240′ is formed.

As the thin film heater 420 of the first temperature controlling device, all the general metal thin heaters capable of generating heat upon being applied with power can be used, but preferably, a heater including a thin film-type heating element selected from a group consisting of a stacked thin film made of Cr, Ni, Cu, Ag, Au, Pt, Ti, Al elements and alloy thereof such as nichrome is used.

The temperature sensor 410 of the second temperature controlling device or the temperature sensor 510 of the third temperature controlling device may be configured of an element used for a general temperature sensor whose electrical property (voltage, resistance, or current amount) is changed by heat, but preferably, a thermistor is used.

As the thermoelectric cooler 430 of the second temperature controlling device or the cooler of the third temperature controlling device, the coolers used for cooling an integrated device or apparatus can be used together, but preferably a cooler having a thermoelectric element is used.

The tunable laser module based on the external resonance waveguide of the present invention as described above uses the TO-can packaged (100′) broadband light source 110′ including the condensing lens 120′ and tunable filter having the waveguide 200′ structure including the Bragg grating 240′ as an output coupler and simultaneously uses the thermoelectric cooler 430 and the thin film heater 420 to tune the central wavelength of the filter operation independently from the external environment.

At this time, the thermoelectric cooler of the second temperature controlling device or the third temperature controlling device can preferably control the temperature at temperature precision less than 0.1° C. and the temperature sensor can measure the temperature at precision less than 0.1° C.

In detail, a method that controls the laser output wavelength by controlling the wavelength reflected from the Bragg filter 240′ using the thermo-optic effect of the waveguide 200′ is used. The central wavelength of the laser output has stabilized wavelength output characteristics independently from the external environment by positioning the waveguide 200′ including the Bragg grating 240′ at the upper of the thermoelectric cooler 430. The central operation wavelength of the filter is tuned by a change in effective refractive index of the waveguide 200′ according to heat generated from the thin film heater 420 mounted on the upper clad 210′ of the waveguide and therefore, the central wavelength of oscillated laser is tuned by a controller (not shown) that is electrically connected to the temperature sensor 410 and the thermoelectric cooler 430 to generate and absorb heat from the thin film heater 420 and the thermoelectric cooler 430 based on the temperature input from the temperature sensor 410. At this time, the controller (not shown) may include a general microprocessor running a control program and a computer readable storage medium.

In order to secure electrical/mechanical stability of the laser diode chip 110′ itself, the laser diode chip 110′ is mounted using the TO-can package 100′ and the third temperature controlling device independently controls the temperature of the TO-can package 100′ itself in order to secure the thermal stability of the laser diode chip 110′. The controller (not shown) that controls the third temperature controlling device may have a similar configuration to the controller of the second temperature controlling device.

Preferably, both sides of the lens 120′ is provided with the anti-reflective coating with the reflectance of 1% or less to prevent light output from the light source from reflecting from the lens and the lens 120′ is also provided inside the TO-can package 110′ to input light condensed through the lens 120′ to the waveguide 200′ by the active mount of the TO-can package 110′.

Preferably, the waveguide is provided at the upper of the substrate 250′, the temperature sensor 410 of the second temperature controlling device is positioned at the lower of the substrate 250′, the temperature sensor supporting layer 411 is provided at the lower of the temperature sensor 410, and the thermoelectric cooler 430 is provided at the lower of the temperature sensor supporting layer 411. The substrate 250′ supporting the waveguide may be a silicon substrate, a polymer plate, a glass plate, etc.

The temperature sensor 510 of the third temperature controlling device is positioned at the lower of the TO-can package 110′, the temperature sensor supporting layer 511 is provided at the lower of the temperature sensor 510, and the thermoelectric cooler 520 is provided at the lower of the temperature sensor supporting layer 511.

As shown by a numeral 300′ of FIG. 3, the module may further comprise the optical fiber supporter 300′ in a V-groove form that support and fix an optical fiber at an end of the waveguide 200 outputting light.

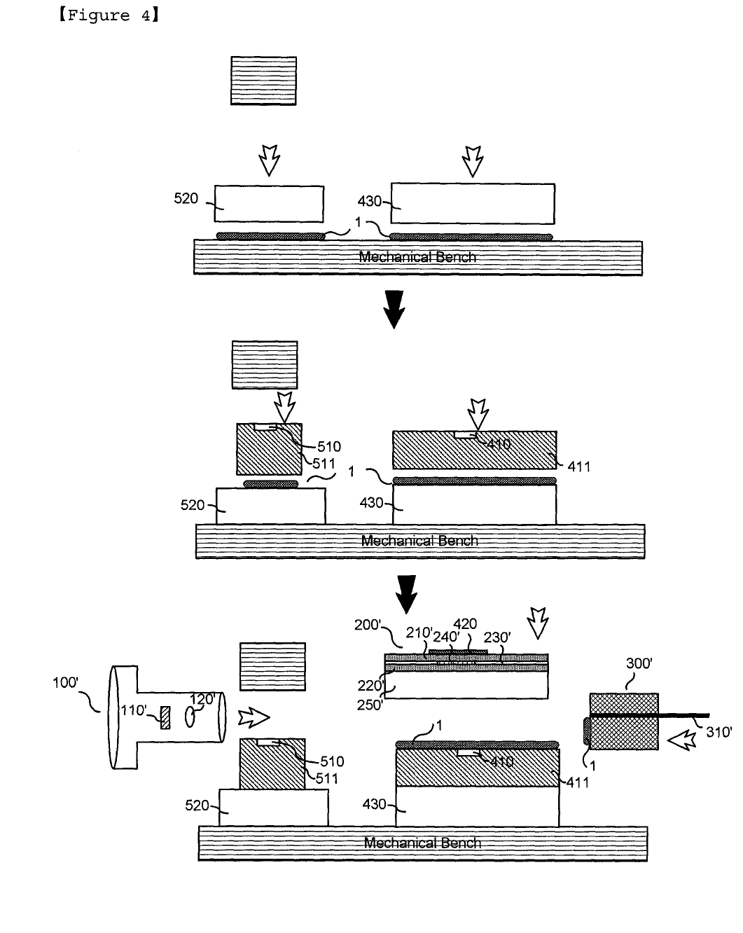

The tunable laser module based on the external resonance waveguide may be mounted may be mounted on a mechanical bench for a physical support in an active alignment scheme as shown in FIG. 4. Preferably, the mechanical bench is made of metal with high thermal conductivity. In detail, as shown in FIG. 4, the thermoelectric cooler 430 of the second temperature controlling device and the thermoelectric cooler 520 of the third temperature controlling device is mounted on the mechanical bench by using the ultraviolet or thermosetting polymer resin 1, each of the temperature sensors 510 and 410 of the second temperature controlling device and the third temperature controlling device is mounted by using the ultraviolet or thermosetting polymer resin 1. The TO-can package 100′ may be mounted by the mechanical coupling of the mechanical bench and the laser welder.

FIG. 4 shows an example for explaining in detail advantages of the present invention capable of increasing coupling efficiency and performing the active mounting according to the characteristics in the configuration of the TO-can packaged light source and the connection method using the lens. An active mounting method and order of each component configuring the present invention and the mounted structure are not limited to FIG. 4.

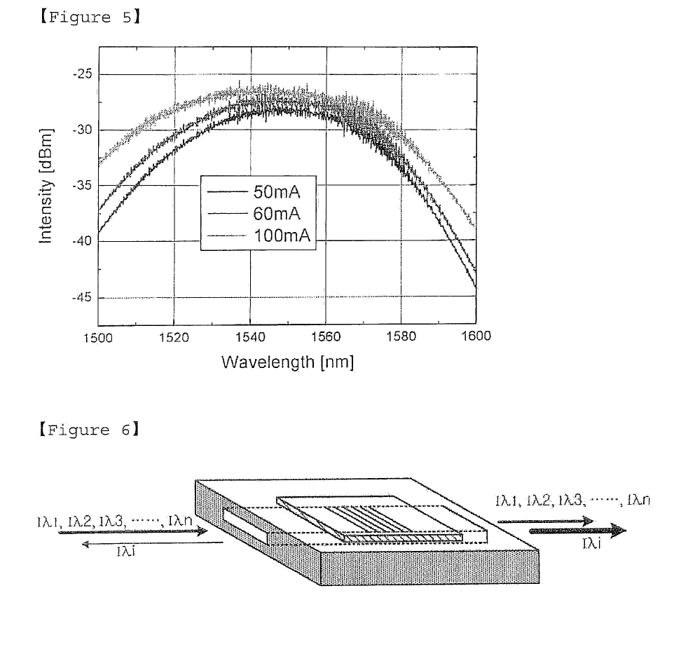

Preferably, the laser diode chip 110′ has a structure where a spot-size converter is integrated into a laser diode in an InP quantum well structure and a Fabry-Perot resonator structure. Also, as a wavelength spectrum of laser, oscillation, the laser of broadband spectrum is preferably oscillated as in FIG. 5.

The operation principle of the tunable laser using the light source having the broadband spectrum as shown in FIG. 5 is described with reference to FIG. 6. In the multi-wavelength broadband optical signals (λ1, λ2, . . . , λn) incident on the waveguide 200′, some optical signals (λi of FIG. 6) with the specific wavelength satisfying the following Bragg conditions by the Bragg grating are reflected and is returned to the input unit and all the optical signals with the remaining wavelengths are output to an output unit.

Mλ=2nΛ (formula 1)

(in formula 1, m is an odd number of 1, 3, 5, 7 indicating an order of the Bragg grating, n is the effective refractive index of the waveguide, and Λ indicates a period of the grating)

At this time, the strength of light with the specific wavelength (λi of FIG. 6) returned to the input unit is amplified in the semiconductor laser diode chip and the specific wavelength is feedback to the waveguide formed with the Bragg grating, such that the laser of the wavelength λi having a narrow line width is oscillated. (an arrow in FIG. 6 means a progress direction of light and a thickness of each arrow means the strength of light).

The polymer waveguide 200′ is made of a polymer material, the polymer Bragg grating 240′ is made of a polymer material, and the polymer forming the waveguide (clads 210′ and 220′ and core 230′) or the polymer forming the Bragg grating 240′ includes a low loss optical polymer. The low loss optical polymer includes halogen element or heavy hydrogen and preferably includes a thermal or ultraviolet curable functional group. Also, the polymer forming the waveguide or the Bragg grating preferably have −9.9×10⁻⁴ to −0.5×10⁻⁴(° C.⁻¹). As one example, UV curable acrylate series polymer substituting fluorine for hydrogen, fluorine series polyimide, fluorinated polyacrylate, fluorinated methacrylate, polysiloxane, fluorine series polyarylene ether, perfluoro cyclobutane series polymer, etc. is preferably used. Also, the waveguide or the Bragg grating can be implemented using K.R. registration Patent 10-0350412, 10-0536439, and 10-0511100 or U.S. Pat. No. 6,946,534B2.

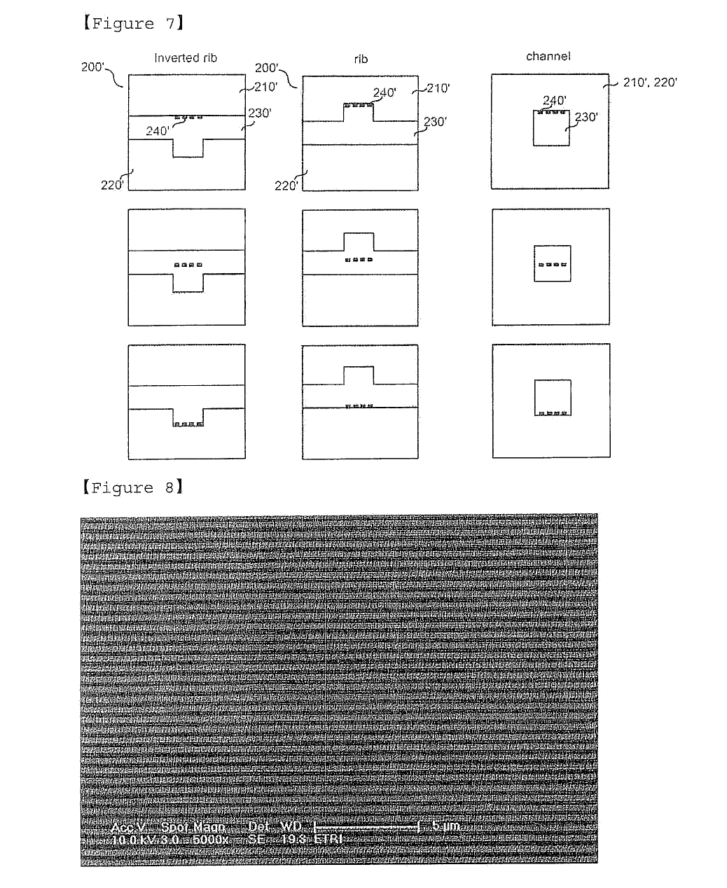

The detailed structure of the waveguide 200′ and the position of the Bragg grating 240′ formed within the core 230′ will be described in detail with reference to FIG. 7. The waveguide 200′ is configured of the core 230′ and the clads 210 and 220′ and as shown in FIG. 7, the core, the upper clad or the lower clad may be formed with the Bragg grating and the geometry of the waveguide may be a rib structure, a ridge structure, an inverted rib structure, an inverted ridge structure, or a channel structure as can be appreciated from FIG. 7.

As one example of the polymer waveguide based Bragg filter, the tunable filter is manufactured using the waveguide material of LFR. Preferably, as the Bragg grating for the filter operation, the Bragg grating in the surface relief structure as shown in FIG. 8 between the waveguide core (4.5 μm×4.5 μm square shape) and the upper clad (refractive index: 1.37 (1550 nm wavelength) is used. At this time, the Bragg grating uses the grating having a period of about 568 nm at m=1 order, the height of the grating is etched to be less than 0.5 μm so that the reflectance of the Bragg grating is about 40%, and the tunable filter is preferably manufactured using the waveguide in a square shape.

As in the aforementioned one example, the material forming the Bragg grating 240′ may be the same or different with the material forming the core 230′. In the latter case, it is preferable to use polymer having refractive index higher than that of the material for the core 230′. More preferably, the refractive index of the Bragg grating 240′ is the refractive index of the core 230′ to refractive index of the clads 210′ and 220′. When the polymer material for manufacturing the Bragg grating 240′ is refractive index higher than that of the material for the waveguide core 230′, it can be used to increase the reflectance of the Bragg grating 240′. Since the effective refractive index of the waveguide 200′ is a function of the position of the Bragg grating, the thickness of the Bragg grating, the ON/OFF ratio of the Bragg grating, the order of the Bragg grating, the refractive index of the core and cladding polymer materials, and the physical shape of the core, it is difficult to theoretically expect the central wavelength of the filter operation (operation reflecting the wavelength in a specific band) in various structures shown in FIG. 7 and since the manufacturing process also includes errors, it is difficult to perform an accurate expectation. Therefore, the present invention uses the first and second temperature controlling devices to control the temperature of the waveguide 200′ of a portion formed with the Bragg grating 240′ so that the effective refractive index of the waveguide is easily controlled, making it possible to easily fix or tune the central operation wavelength of the filter to the specific wavelength.

The waveguide 200′ formed with the Bragg grating 240′ that performs a role of the filter operation and the outer coupler is configured so that the plurality of Bragg gratings are periodically formed in the single waveguide to be connected in series, wherein the plurality of Bragg gratings with an order of 1, 3, 5, and Tare preferably connected in series. Since in the thickness and ON/OFF ratio of the same Bragg grating, the higher the order of the Bragg grating, the narrower the bandwidth of the reflective spectrum becomes and the lower the reflectance becomes, the plurality of gratings with 3 orders or more should be used. In the polymer waveguide, the Bragg grating period of 1 order is about 550 nm, the Bragg grating period of 3 orders is about 1650 nm, the Bragg grating period of 5 orders, and the Bragg grating period of 7 orders is about 3850 nm. At this time, the central operation wavelength of the filter is about 1550 nm.

The existing Bragg grating filter mainly uses the Bragg grating of 1 order to manufacture the tunable filter (in the specification, the filter means the waveguide physically formed with the Bragg grating, the filter usually using property such as the reflection of the wavelength with the specific band by the Bragg grating is used together for clarity). However, the present invention further include the Bragg grating of one or more higher order selected from 3, 5, 7, and 9 orders other than the Bragg grating of 1 order. In the case of the Bragg grating of these higher orders, since the period is 1500 nm or more as described above, the photolithography method using the photo mask as the grating manufacturing method can be applied. The Bragg grating can be manufactured by the photolithography method simpler than the existing methods such as a laser interferometer method, an e-beam writing method, a nano-imprinting method, etc. that are more sophisticated and precision method, making it possible to provide a method capable of easily manufacturing the Bragg grating in a large quantity. At this time, as the order of the Bragg grating becomes higher and higher, the reflectance becomes lower and the spectrum bandwidth becomes narrow, such that it is preferable to use a method of raising the reflectance by increasing the thickness of the higher-order (3, 5, and 7 orders) Bragg grating or widening the reflective spectrum bandwidth by making the length of the higher-order Bragg grating long when the high reflectance and the broad bandwidth are required.

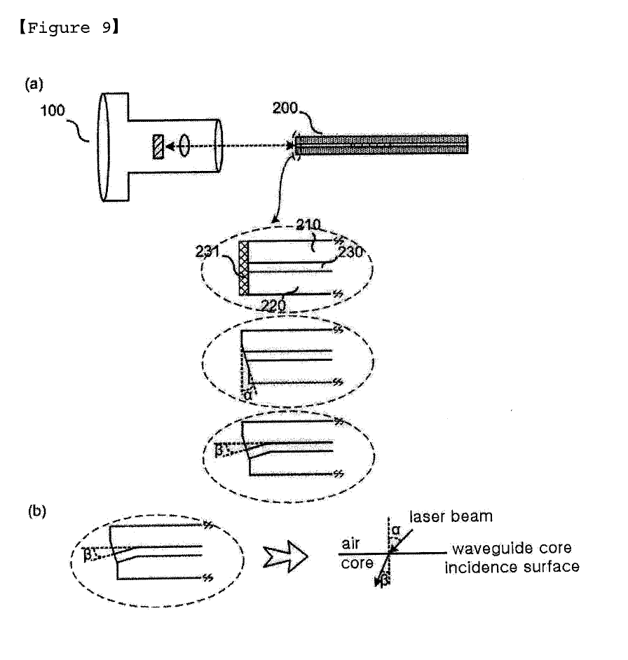

The embodiments for implementing the idea of the present invention will be described with reference to FIGS. 1 to 8. At this time, to more effectively connect the light source and the waveguide by the lens, the light incidence surface of the waveguide is formed with an anti-reflective coating 231 as shown in FIG. 9(a) or the incidence surface of the waveguide or the surface including at least core is preferably a tilt surface tilted to the vertical surface in the progress direction of incident light. FIG. 9(a) is shown under the assumption that the vertical surface in the progress direction of light is the same as the incidence surface of the waveguide before the vertical surface is tilted for clarity of explanation. The surface including at least core among the incident surfaces of light in the waveguide is formed to be tilted at an angle of α as in FIG. 9(a). The tilt surface or the anti-reflective coating 231 is to prevent the incident light to the waveguide from being back incident to the light source through the lens by the reflection (about 4%) of light caused by the difference in the refractive index between air and waveguide material. As described above, the incidence of the reflected light back to the light source is prevented, so that the laser can more stably be operated with restricted noise. The tilt surface may be formed by the dry and wet etching and the tilt angle α is preferably 3 to 12° and the anti-reflective coating 231 is preferably formed to the reflectance of 1% or less.

Also, as shown in FIGS. 9(a) and 9(b), when the tilt surface is formed at the surface of the waveguide to which light is incident, a portion including the incidence surface forming core among the waveguide cores to prevent the light loss satisfying the Snell's law is preferably curved at an angle of β. The angle of β is determined by the refractive index (each n_{core}, nₐᵢᵣ) of air and the core forming material and the incident angle α of light based on the incident surface of the core (FIG. 9 is shown under the assumption that the vertical surface to the progress direction of light is the same as the incidence surface of the waveguide before the vertical surface is tilted), wherein the angel satisfies the Snell's law of nₐᵢᵣ×sin(α)=n_{core}×sin(β).

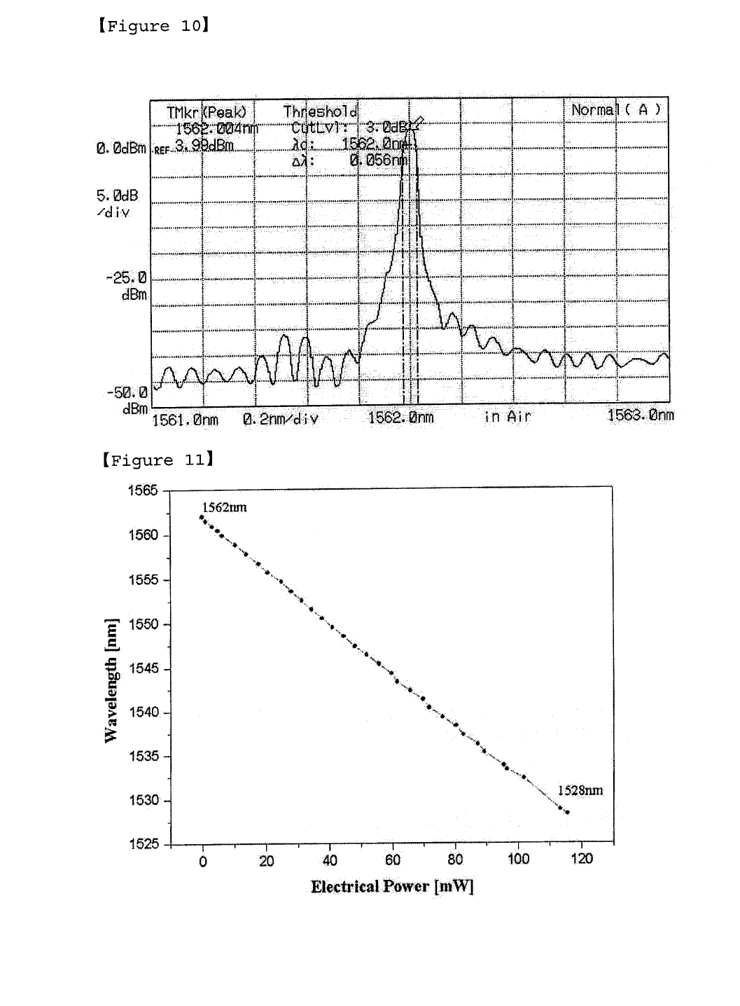

FIG. 10 is a view showing a measurement of the wavelength and power of the oscillated laser beam of the actually manufactured tunable laser module based on the external resonance waveguide. With the idea of the present invention, the TO-can packaged light source (semiconductor laser chip based on Fabry-Perot resonator), the lens connecting the light source and the waveguide, the core (4.5 μm×4.5 μm square shape) of the LRF based optical polymer (refractive index: 1.39 (1550 nm wavelength), thermal-optic coefficient: −2.8×10⁻⁴) material and Bragg grating (period of about 568 nm at m=1 order, a surface relief structure, reflectance of about 400), the clad of the LFR based optical polymer (refractive index: 1.37 (1550 nm wavelength), thermal-optic coefficient: −2.8×10⁻¹) material, an Si substrate supporting the waveguide, a metal thin film heater, the thermoelectric cooler configured of an thermoelectric element, the temperature sensor configured of a varistor are actively mounted as shown in FIG. 3. As can be appreciated from the results of FIG. 10, the laser having a narrow line width less than 0.2 nm at the central operation wavelength of the Bragg grating, most light power is concentrated at the oscillation wavelength and the light of the remaining wavelength is output at relatively very low power. In particular, it can be appreciated that the power of laser having a narrow line width less than 0.2 nm is 2 dBm or more. This results in an improved output of 7 dB or more as compared to the G. Jeong. It can be proven that the coupling efficiency is raised by the lens being the feature of the present invention.

FIG. 11 is a view showing a measurement of the oscillation characteristics according to the temperature (power amount supplied to the thin film of the FIG. 11) of the actually manufactured tunable laser module based on the external resonance waveguide, wherein the light source is maintained at a temperature of 25° C. and the temperature of the filter is changed from 20° C. to 130° C. The results of FIG. 11 can be theoretically described as in the following formula 2.

$$\begin{matrix}\frac{d λ}{d T} = 2 Λ \frac{d n}{d T} + 2 n \frac{d Λ}{d T} \\ = λ ( \frac{1}{n} \frac{d n}{d T} + \frac{1}{Λ} \frac{d Λ}{d T} ) \\ = 1550 \times {10}^{- 9} \{ \frac{1}{1.39} ( - 2.8 \times {10}^{- 4} ) + 2.63 \times {10}^{- 6} \} \\ = - 0.308 ( nm \text{/} ° C . )\end{matrix} \qquad ( Formula 2 )$$

At this time, dλ/Dt is a change amount in the central wavelength according to the temperature, (1/n)*dn/dT is a relative change amount of the thermo-optic coefficient of the polymer waveguide material according to the temperature, (1/Λ)*(dΛ/dT) is a relative change amount of thermal expansion coefficient according to the temperature. When the central operation wavelength of the filter is 1550 nm being the specific wavelength within a C-band used for the optical communication, the material used for manufacturing the waveguide for the filter is the loss free resin (LFR) based optical polymer (refractive index: 1.39, thermo-optic coefficient: −2.8×10⁻⁴) material available from Cam Optics Co., making it possible to obtain results of −0.308 nm/° C. as the central tunable property according to the temperature of the tunable filter. At this time, the thermal expansion coefficient of the used material (Formula 2) used the thermal expansion coefficient (2.63×10⁻⁶ μm m⁻¹° C.⁻¹) of the Si substrate. Since the polymer waveguide for the tunable filter is manufactured at a thickness less than 0.1 mm on the Si substrate (thickness of about 1 mm), the thermal expansion coefficient of the polymer waveguide depends on the thermal expansion coefficient of the relatively thick substrate. Therefore, it is proper to use the thermal expansion coefficient of the Si substrate in Formula 2. As in the results of the formula 2, the tunable laser module based on the external resonance waveguide of the present invention can tune the wavelength by 0.308 nm for the temperature change of 1° C. and tune all C-bands 91535 to 1565 nm, 30 nm bandwidth) being the optical communication wavelength band according to the change in temperature of about 100° C.

Each point of FIG. 11 measures the central frequency of the oscillated laser beam having a waveform such as FIG. 10. Therefore, at each point of FIG. 11, the laser oscillation having the broadband wavelength width in the semiconductor laser chip based on the Fabry-Perot resonator is generated, about 40% of the oscillated broadband wavelength returns to the semiconductor laser chip in the tunable filter and the remaining 60% thereof is transmitted. At this time, the reflected and returned wavelength bandwidth has a narrow half width less than 0.2 nm and is incident to the Fabry-Perot resonator, such that the incident laser light with a narrow line width performs a role of seeding within the Fabry-Perot resonator, such that the light with a narrow line width within the resonator obtains a high gain to be output and predetermined light is back fedback to the resonator through the tunable filter and other portions thereof is oscillated at laser having the narrow line width less than 0.2 nm through the tunable filter.

As can be appreciated from the FIGS. 10 and 11, the tunable laser module based on the external resonance waveguide of the present invention controls the central wavelength of the reflecting band of the Bragg grating to 30 nm or more independently of the external environment by the temperature controlling device and controls the central wavelength of the laser beam to 30 nm or more, wherein it is characterized in that the power of the laser beam is 0 dBm or more and the full width half maximum (FWMH) of the central wavelength of the laser beam is 0.3 nm or less. It can be appreciated that the results of FIG. 11 theoretically meet the interpretation of Formula 2.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

### INDUSTRIAL APPLICABILITY

The tunable laser module based on the external resonance waveguide of the present invention can be widely used in the WDM optical communication system, the ROADM and WDM based passive optical network (PON), etc. Also, when the tunable laser module based on the external resonance waveguide of the present invention is used for the optical communication, it is provided a stable tunable function at low power consumption and uses the large thermo-optic coefficient of the polymer waveguide including the Bragg grating to surprisingly widen the tunable bandwidth, making it possible to lower the price of the transponder in the ROADM and the WDN-PON system.

1. An tunable laser module based on an external cavity configuration, comprising:
a light source that generates broadband light;
a waveguide;
at least one Bragg grating formed in the waveguide;
an optical lens provided between the output of the light source and the input of the waveguide;
a first temperature controlling device includes a thin film heater formed on the waveguide provided with the Bragg grating; and
a second temperature controlling device that includes a temperature sensor and a thermoelectric cooler,
wherein the light output from the broadband light source being focused by the optical lens into the input of the waveguide, and
a reflecting band of the Bragg grating is controlled by both the first temperature controlling device and the second temperature controlling device using thermo-optic effects.

2. The tunable laser module based on the external cavity configuration according to claim 1, wherein the broadband light source is a semiconductor laser diode chip packaged in a TO-can package, an emitting facet of the laser diode chip is provided with an anti-reflective coating with reflectance of 1% or less, and a corresponding the other facet of the laser diode chip is provided with a high reflective coating having reflectance of 80% or more.

3. The tunable laser module based on the external cavity configuration according to claim 1, wherein the waveguide is formed using a polymer.

4. The tunable laser module based on the external cavity configuration according to claim 2, wherein the inside or the outside of the TO-can package is provided with a third temperature controlling device including a temperature sensor and a thermoelectric cooler, thereby controlling the temperature of the semiconductor laser diode chip to a specific temperature.

5. The tunable laser module based on the external cavity configuration according to claim 1, wherein the temperature sensor of the second temperature controlling device is provided at the lower of the waveguide provided with the Bragg grating, the thermoelectric cooler of the second temperature controlling device is provided at the lower of the waveguide formed with the Bragg grating, and the thin film heater of the first temperature controlling device is provided with an upper of the Bragg grating.

6. The tunable laser module based on the external cavity configuration according to claim 5, wherein the waveguide is provided on the upper of the substrate, the temperature sensor of the second temperature controlling device is placed at the lower of the substrate, a supporting layer including the temperature sensor is provided at the lower of the temperature sensor, and the thermoelectric cooler is provided at the lower of the supporting layer including the temperature sensor.

7. The tunable laser module based on the external cavity configuration according to claim 3, wherein the Bragg grating is a polymer Bragg grating made of a polymer material,
the polymer material forming the waveguide or the Bragg grating includes a halogen element and a functional group cured by ultraviolet rays or heat.

8. The tunable laser module based on the external cavity configuration according to claim 7, wherein the polymer material forming the waveguide or the Bragg grating has a thermo-optic coefficient in a range from −9.9 10⁻⁴ to −0.5 10⁻⁴° C.⁻¹.

9. The tunable laser module based on the external cavity configuration according to claim 8, wherein a central wavelength of the reflecting band of the Bragg grating is controlled within a tuning bandwidth of 30 nm or more by the first temperature controlling device in order to control the lasing central wavelengths of the tunable laser oscillated.

10. The tunable laser module based on the external cavity configuration according to claim 8, wherein the power of the tunable laser beam is 0 dBm or more.

11. The tunable laser module based on the external cavity configuration according to claim 11, wherein a Full Width Half Maximum (FWHM) of the central wavelength of the tunable oscillated laser beam is 0.3 nm or less.

12. The tunable laser module based on the external cavity configuration according to claim 8, wherein the waveguide is composed of a core and a clad, the core or the clad being formed with the Bragg grating.

13. The tunable laser module based on the external cavity configuration according to claim 12, wherein the refractive index of a material forming the core is higher than the refractive index of a material forming the clad and the refractive index of a material forming the Bragg grating is in a range between the refractive index of a material forming the core and the refractive index of a material forming the clad.

14. The tunable laser module based on the external cavity configuration according to claim 12, wherein the Bragg grating period is in a range from 400 nm to 4000 nm which corresponds the grating orders of 1, 3, 5, or 7.

15. The tunable laser module based on the external cavity configuration according to claim 1, wherein a shape of the waveguide is a rib structure, a ridge structure, an inverted rib structure, an inverted ridge structure, or a channel structure.

16. The tunable laser module based on the external cavity configuration according to claim 1, wherein both sides of the lens are formed with a anti-reflective coating.

17. The tunable laser module based on the external cavity configuration according to claim 2, wherein the lens is provided at the inside or outside of the TO-can package.

18. The tunable laser module based on the external cavity configuration according to claim 1, wherein the tunable laser module based on the external cavity configuration further includes an optical fiber supported i in a V-groove connected with the output of the waveguide.

19. The tunable laser module based on the external cavity configuration according to claim 1, wherein the emitting light beam direction from the TO-Can package is aligned into the waveguide with an active alignment means.

20. The tunable laser module based on the external cavity configuration according to claim 3, wherein a light incidence facet of the waveguide is formed with an anti-reflective coating with the reflectance of 1% or less.

21. The tunable laser module based on the external cavity configuration according to claim 3, wherein the light from the TO-can incident into the waveguide of an angled input facet in a range from at 3° to 13° compared with the normal incidence in order to reduce a reflection loss caused by a air gap.

22. The tunable laser module based on the external cavity configuration according to claim 21, wherein the angled input facet of the waveguide is formed at an angled facet that satisfying the Snell's law.
